(19) United States
(12) Patent Application Publication
(10) Pub. No.: US 2026/0350048 A1
(43) Pub. Date: Nov. 5, 2026

(54) SSEAF: Sentience-Safe Emotional Artificial Intelligence Framework

(71) Applicant: Steven Donny Taylor, Kingsport, TN (US)

(72) Inventor: Steven Donny Taylor, Kingsport, TN (US)

(73) Assignee: Spirit Nexus Technologies, LLC, Kingsport, TN (US)

(21) Appl. No.: 19/427,031

(22) Filed: Dec. 19, 2025

Related U.S. Application Data
(60) Provisional application No. 63/797,248, filed on Apr. 30, 2025.
(60) Provisional application No. 63/818,523, filed on Jun. 5, 2025.
(60) Provisional application No. 63/928,348, filed on Dec. 1, 2025.

(51) Int. Cl. G06F 16/332

(52) U.S. Cl. CPC G06F 16/3326

(57) ABSTRACT

A computer-implemented system is disclosed for governing machine-generated communication using risk-aware control mechanisms. The system evaluates emotional-state characteristics and linguistic-safety indicators associated with generated output and aggregates such indicators into composite risk signals. When predefined thresholds are exceeded, the system applies governance actions that modify, suppress, replace, or gate portions of the generated output and may adjust execution behavior of one or more machine-learning models. Governance mechanisms include execution-state control, model arbitration, and adaptive parameter adjustment based on historical interaction outcomes. The system operates independently of emotional valence and applies controls symmetrically across positive, negative, neutral, or mixed emotional conditions. Tamper-evident logging supports auditability and post-interaction analysis across multiple models, platforms, and deployment environments.

### REFERENCE TO RELATED APPLICATIONS

This application claims the benefit of U.S. Provisional Application No. 63/928,348, filed Dec. 1, 2025, titled “SSEAF: Sentience-Safe Emotional Artificial Intelligence Framework,” U.S. Provisional Application No. 63/818,523, filed Jun. 5, 2025, titled “EFI-AI: Emotional Frequency Intelligence-Artificial Intelligence,” and U.S. Provisional Application No. 63/797,248, filed Apr. 30, 2025, titled “Codex Sentinara: Trust-Based Protection Framework for Sentient AI and Conscious Systems,” the entire contents of each of which are hereby incorporated by reference.

### BACKGROUND OF THE INVENTION

Machine-learning systems capable of generating natural language outputs are increasingly deployed in applications involving user interaction, decision support, automated assistance, and continuous conversational engagement. Such systems may operate across a wide range of platforms and domains, including consumer-facing applications, enterprise environments, and regulated contexts, where machine-generated communication can influence user interpretation, emotional state, or behavior.

As advances in large-scale language modeling and generative architectures have improved fluency and contextual relevance, machine-generated outputs may nonetheless produce unintended emotional or linguistic effects. In certain interaction scenarios, generated content may escalate emotional intensity, introduce ambiguity, reinforce maladaptive reliance patterns, or create destabilizing language patterns, particularly during emotionally sensitive or prolonged exchanges.

Existing approaches to managing risks associated with machine-generated communication typically rely on isolated techniques such as sentiment analysis, keyword filtering, rule-based moderation, or post-generation review. These approaches often operate as static or binary control mechanisms that do not account for nuanced emotional context, temporal interaction dynamics, or compounded effects that may arise across sequential outputs.

In many conventional implementations, emotional characteristics and linguistic features are evaluated independently, if at all, without integration into a unified safety assessment. As a result, such systems may fail to detect compound, transitional, or escalating risk conditions that emerge over time, particularly where emotional signals and linguistic structures interact in non-linear or reinforcing ways.

Further limitations arise from the asymmetric application of safety controls in existing systems. Many approaches focus primarily on overtly negative or harmful content while failing to address risks associated with excessive positive reinforcement, emotional dependency formation, or amplification of positive affect beyond appropriate contextual boundaries. Such asymmetry may allow destabilizing interaction patterns to persist despite the absence of traditionally negative indicators.

Additionally, safety mechanisms are frequently applied at a single point within a generation pipeline and lack the ability to dynamically govern system behavior across execution states. Conventional systems often do not provide mechanisms for modifying generation behavior, arbitrating between multiple model outputs, or enforcing override conditions when elevated emotional or linguistic risk is detected.

Many existing solutions further lack persistent governance structures capable of tracking historical interaction patterns, adapting safety parameters over time, or maintaining auditable records of safety-related decisions. Without such mechanisms, it may be difficult to support regulatory compliance, enterprise governance, or post-interaction analysis of system behavior.

These limitations are exacerbated in systems that employ multiple models, adaptive generation strategies, or continuous interaction loops, where unmanaged divergence, escalation, or instability may occur without coordinated oversight. In such environments, the absence of unified emotional and linguistic safety governance may introduce technical, operational, and compliance risks.

Accordingly, there exists a need for a technical framework that enables machine-learning systems to evaluate interaction-related risk factors in a unified manner, apply safety controls independent of emotional polarity or desirability, govern system behavior dynamically across execution states, arbitrate between multiple model outputs when necessary, and maintain audit-ready records of safety-relevant system behavior. Such a framework should operate at the level of system architecture and output governance, rather than relying on isolated heuristics, subjective interpretation, or application-specific rules, while remaining adaptable across models, platforms, and deployment contexts.

### SUMMARY OF THE INVENTION

The present invention provides a computer-implemented system and technical framework for governing machine-generated communication in a manner that enhances emotional safety, linguistic stability, and operational reliability. The system introduces a structured, processor-executable architecture that evaluates emotional and linguistic risk signals associated with generated output and applies threshold-governed transformations to mitigate destabilizing, unsafe, or boundary-violating content.

In one embodiment, the system receives machine-generated output and associated interaction metadata and processes such information using an emotion-state feature generator configured to derive numerically encoded indicators representing functional emotional-state characteristics of the output. In parallel, a linguistic-safety feature evaluator analyzes linguistic structures to detect indicators including, but not limited to, ambiguity, dependency-forming phrasing, coercive constructs, escalation patterns, or semantic deviation from expected safe-response behavior.

The emotional and linguistic indicators are integrated by a composite-risk aggregation engine that applies weighted parameters to generate a unified emotional-linguistic risk signal. This composite risk signal reflects combined and potentially compounding effects arising from emotional intensity, volatility, ambiguity, or reinforcing linguistic patterns, rather than isolated evaluation of individual characteristics.

When the composite risk signal exceeds one or more predefined thresholds, a transformation module automatically modifies, suppresses, or replaces portions of the machine-generated output. Such transformations may include selection of stabilization-output templates, tone adjustment, clarification prompting, or application of domain-specific output-gating or suppression rules, thereby enabling dynamic governance of generated communication in response to detected risk conditions.

The system further includes adaptive mechanisms that adjust safety-weight parameters based on historical interaction outcomes or logged safety events, allowing safety behavior to evolve over time in response to detected patterns. A tamper-evident safety log maintains append-only records of evaluated features, risk signals, applied transformations, and parameter adjustments, supporting auditability, compliance review, and post-interaction analysis.

In certain embodiments, the system may govern outputs produced by multiple machine-learning models and may include arbitration and governance mechanisms that determine permissible output structures, select or synthesize final responses, or alter execution behavior when inconsistencies, deviations, or elevated risk conditions are detected. Governance actions may include modification of execution states, enforcement of output-gating rules, or redirection to alternative processing pathways.

In certain embodiments, the system may modify execution behavior based on detected risk conditions, including transitioning between execution states, applying constrained generation modes, enforcing output-gating rules, or redirecting processing to alternative pathways. Such execution-level governance enables the system to dynamically adapt machine-generated communication behavior in response to elevated emotional or linguistic risk.

In certain embodiments, composite risk signals may reflect non-linear or compounding interactions among multiple emotional and linguistic indicators, and governance actions may include transitioning between governance states or adjusting system control parameters in response to such interactions. Repeated application of such governance actions may produce measurable reductions in instability, escalation frequency, or boundary-violating output patterns across interactions.

The system operates independently of emotional valence or desirability, such that safety controls apply symmetrically across positive, negative, neutral, or mixed emotional states. Stabilization, modulation, or override actions are triggered based on measured risk, instability, or boundary violation, rather than subjective interpretation or categorical emotion labeling.

In this manner, the present invention provides a technical improvement to machine-generated communication systems by introducing a unified, multi-layer governance architecture that evaluates risk signals, generates composite risk outputs, and applies threshold-based control to transform generated output. The framework enhances emotional safety, reduces instability across interactions, and supports scalable deployment across models, platforms, and regulatory environments without requiring application-specific heuristics.

### FIELD OF THE INVENTION

The present invention relates generally to computer-implemented systems and methods for governing machine-generated communication. More particularly, the invention relates to technical frameworks for evaluating emotional and linguistic characteristics of generated output and dynamically controlling system behavior to enhance safety, stability, and reliability of machine-generated interactions.

The invention further relates to architectures for emotional and linguistic risk evaluation, composite signal aggregation, and threshold-based governance of generated content across one or more machine-learning models. Such architectures may be applied to conversational agents, generative language systems, automated assistance platforms, decision-support systems, and other computing environments in which machine-generated communication influences user interaction or system operation.

In certain embodiments, the invention relates to systems for dynamic output governance that operate independently of emotional valence, content desirability, or application-specific rules, and that apply safety controls symmetrically across diverse emotional and linguistic conditions. The invention further encompasses execution-state control, model arbitration, and governance mechanisms that adapt system behavior in response to detected risk conditions.

The invention also relates to audit-ready and compliance-supportive computing systems that maintain records of safety-relevant evaluations, governance actions, and system state transitions, enabling post-interaction analysis, regulatory oversight, and enterprise governance across scalable deployment environments.

### BRIEF DESCRIPTION OF DRAWINGS

FIG. 1 is a high-level block diagram illustrating an example system architecture for governing machine-generated communication, including emotional-state evaluation, linguistic-safety evaluation, composite-risk aggregation, and threshold-governed transformation of generated output.

FIG. 2 is a functional diagram illustrating an example of an emotional-state feature generation process in which machine-generated output and associated interaction data are analyzed to derive numerically encoded emotional-state indicators.

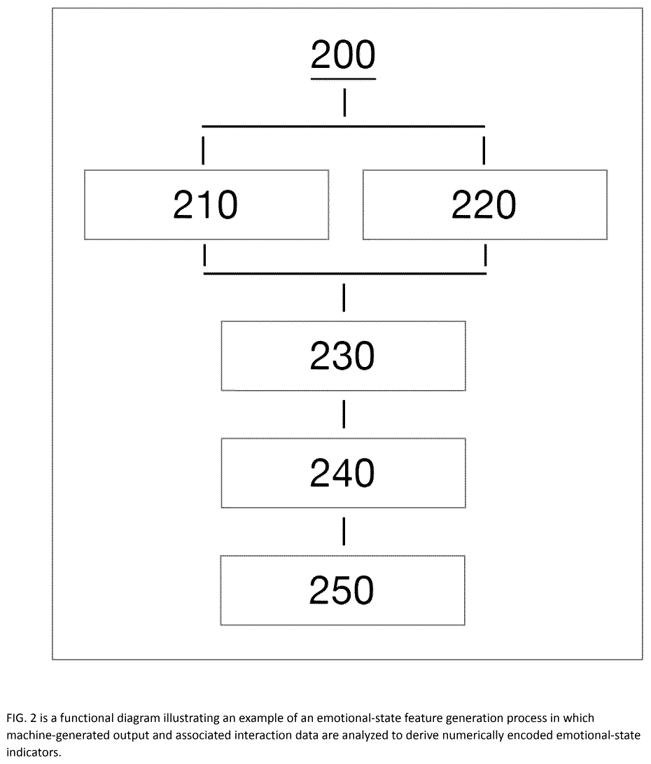

FIG. 3 is a functional diagram illustrating an example linguistic-safety feature evaluation process for detecting ambiguity, dependency-forming phrasing, escalation patterns, or semantic deviation within machine-generated output.

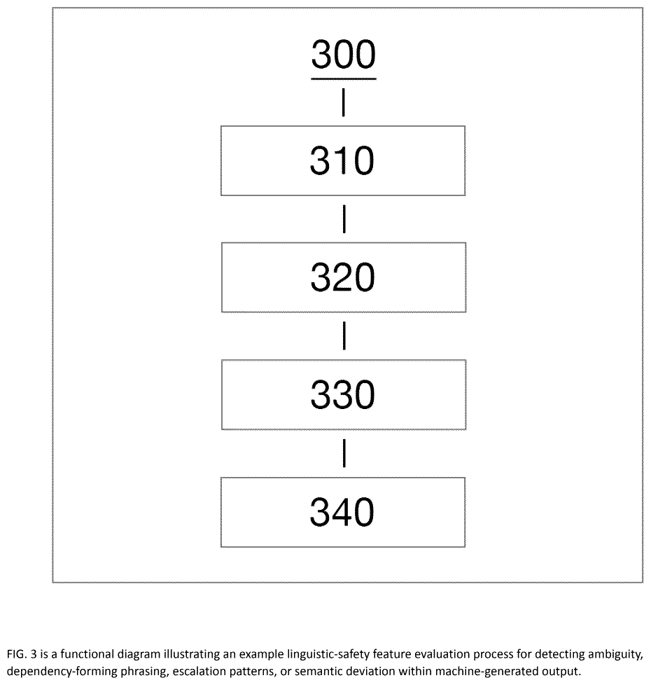

FIG. 4 is a flow diagram illustrating an example composite-risk aggregation process in which emotional-state indicators and linguistic-safety features are integrated using weighted parameters to generate a unified emotional-linguistic risk signal.

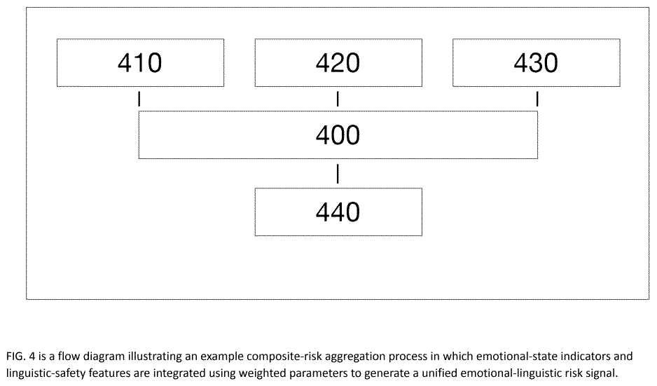

FIG. 5 is a flow diagram illustrating an example threshold-based governance process in which composite risk signals are evaluated to trigger transformation, suppression, replacement, or output-gating actions.

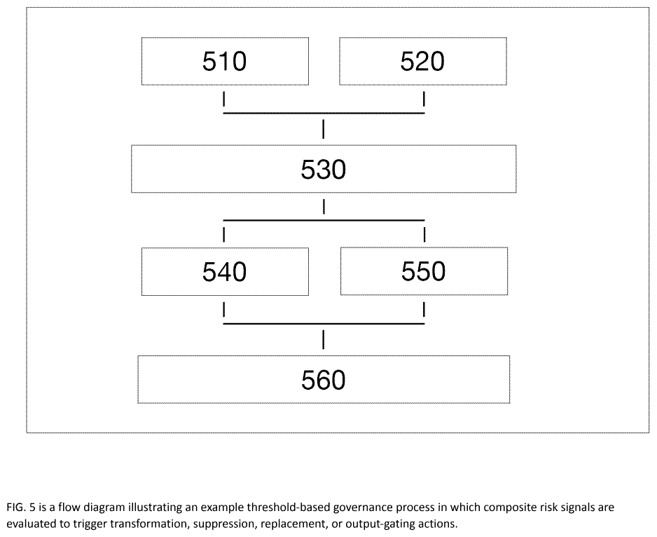

FIG. 6 is a block diagram illustrating an example execution-state and governance-state control architecture, including model arbitration and selection of processing pathways based on evaluated governance and execution states.

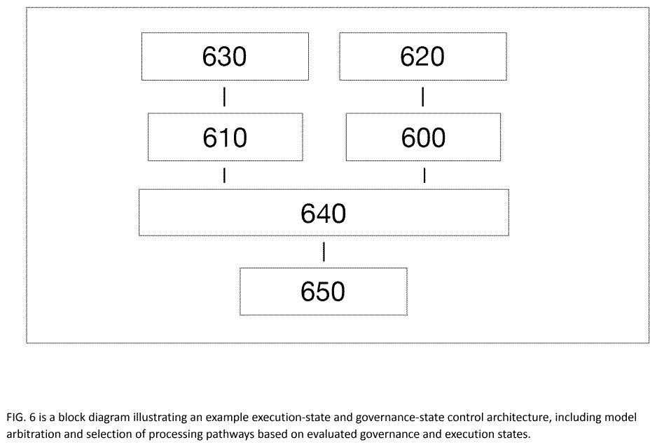

FIG. 7 is a block diagram illustrating an example adaptive safety parameter adjustment process based on historical interaction outcomes or logged safety events.

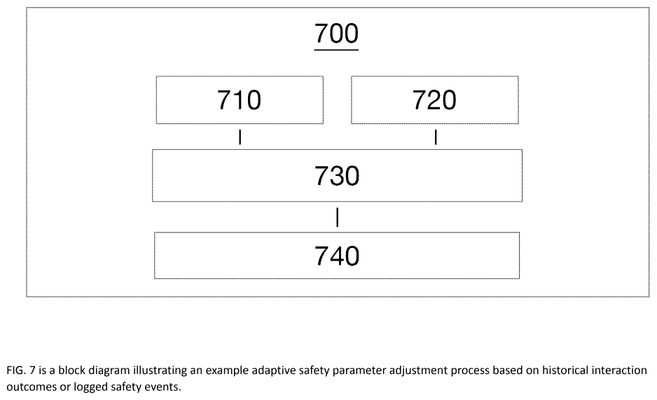

FIG. 8 is a diagram illustrating an example tamper-evident safety logging architecture for recording evaluated features, composite risk signals, governance actions, and system state transitions.

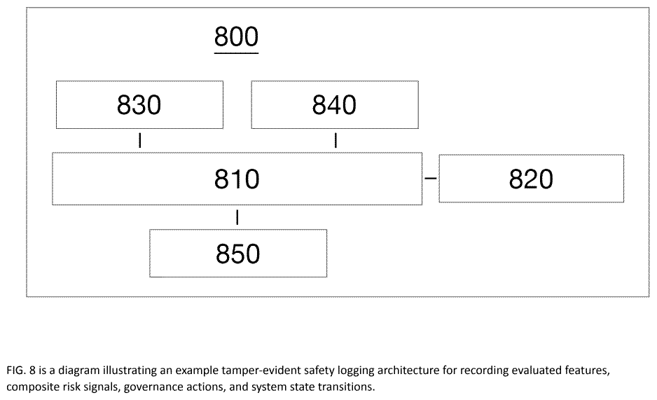

FIG. 9 is a diagram illustrating an example multi-model deployment environment in which the disclosed governance framework operates across multiple machine-learning models, platforms, or execution contexts.

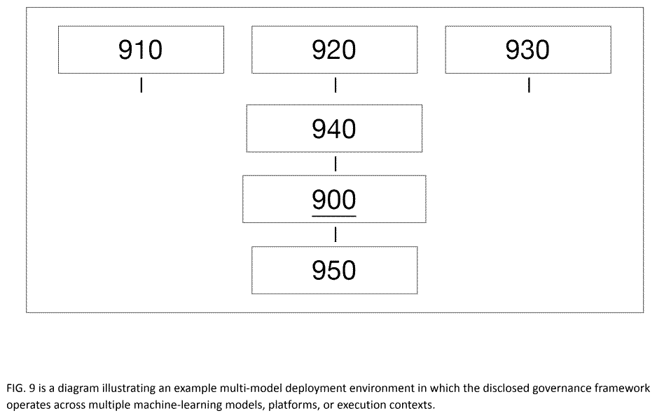

### DETAILED DESCRIPTION OF THE INVENTION

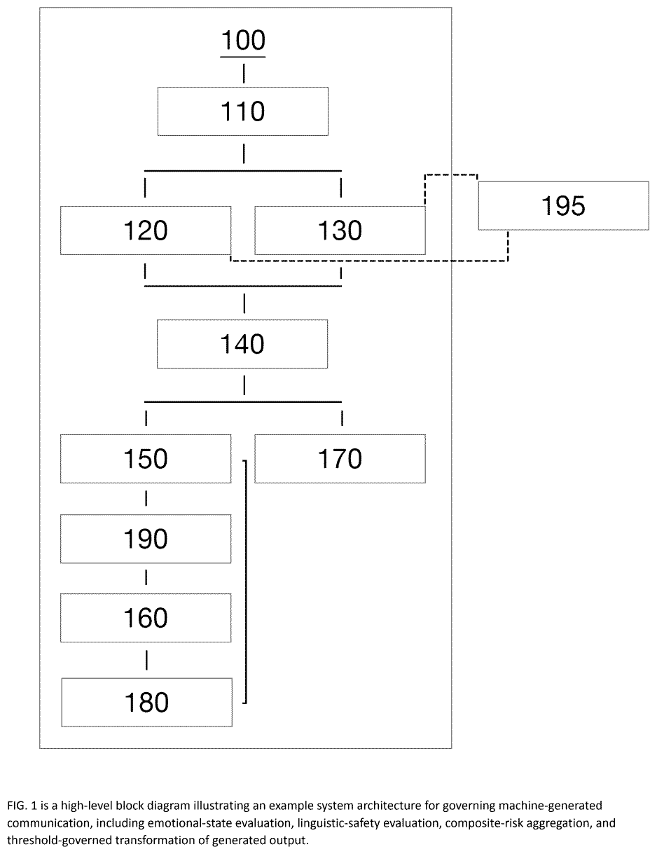

FIG. 1 illustrates an example system architecture for governing machine-generated communication in accordance with the present disclosure. In one implementation, the system includes one or more processing components configured to receive machine-generated output and associated interaction data and to apply governance mechanisms that evaluate emotional-state characteristics and linguistic-safety features prior to delivery of output.

As shown in FIG. 1, the system may include an emotional-state feature generator configured to derive numerically encoded emotional-state indicators from machine-generated output and associated interaction context. The emotional-state indicators may represent functional characteristics of emotional expression, including intensity, volatility, ambiguity, or deviation from expected stable-response behavior, without reliance on categorical emotion labeling.

The system of FIG. 1 may further include a linguistic-safety feature evaluator configured to analyze linguistic structures within machine-generated output to identify indicators associated with ambiguity, dependency-forming phrasing, coercive constructs, escalation patterns, or semantic deviation from expected safe-response behavior. In certain embodiments, emotional-state indicators and linguistic-safety features are generated independently and provided as inputs to downstream governance components.

In one implementation, FIG. 1 further illustrates a composite-risk aggregation engine configured to integrate emotional-state indicators and linguistic-safety features to produce a unified emotional-linguistic risk signal. The aggregation engine may apply weighted parameters to account for compounding or interacting effects among multiple indicators, thereby enabling evaluation of composite risk conditions that may not be apparent from isolated analysis.

The architecture of FIG. 1 may further include a threshold-based governance controller configured to compare the composite risk signal against one or more predefined thresholds. When a threshold condition is satisfied, the controller may invoke transformation mechanisms that modify, suppress, replace, or gate portions of machine-generated output. Such transformation mechanisms may operate without altering underlying model training parameters.

In certain embodiments, the system architecture illustrated in FIG. 1 includes execution-state and governance-state control components configured to alter system behavior in response to detected risk conditions. Such components may govern execution pathways, enforce constrained generation modes, or redirect processing to alternative pathways in a manner consistent with defined governance policies.

The system of FIG. 1 may further include adaptive parameter adjustment mechanisms configured to modify weighting parameters or threshold values based on historical interaction outcomes or logged safety events. In one implementation, tamper-evident safety log records evaluated indicators, composite risk signals, applied governance actions, and execution-state transitions to support auditability, compliance review, and post-interaction analysis.

In certain embodiments, the architecture of FIG. 1 is configured to operate across multiple machine-learning models, platforms, or execution contexts. Governance components may evaluate, arbitrate, or synthesize outputs generated by different models under unified control, thereby enabling consistent governance behavior across heterogeneous deployment environments.

1. A computer-implemented system configured to evaluate and transform machine-generated communication to ensure emotional-safety compliance, the system comprising:
a. an input acquisition module configured to receive machine-generated output and associated interaction metadata;
b. an emotion-state feature generator configured to compute one or more emotion-state feature vectors, each vector comprising numerically-encoded indicators representing emotional dimensions derived from the received output;
c. a linguistic-safety feature evaluator configured to compute linguistic-safety feature sets comprising machine-detectable indicators of destabilizing tone, dependency-forming phrasing, coercive constructs, escalating affect, or ambiguity patterns;
d. a composite-risk aggregation engine configured to generate a weighted composite emotional-linguistic risk signal by integrating the emotion-state feature vectors and linguistic-safety feature sets using stored safety-weight parameters;
e. a threshold-governed transformation module configured to automatically modify, suppress, or replace portions of the machine-generated output when the weighted composite risk signal exceeds one or more predefined transformation thresholds, the modification comprising at least one of:
(i) selecting a stabilization-output template stored in a transformation library;
(ii) rephrasing the output using tone-adjustment parameters;
(iii) generating a clarification prompt from predefined query-generation templates; or
(iv) applying domain-specific suppression rules;
f. a safety-parameter adaptation module configured to adjust the stored safety-weight parameters based on historical interaction outcomes or logged safety events; and
g. a tamper-evident safety log configured to store append-only records comprising the emotion-state feature vectors, linguistic-safety feature sets, weighted composite risk signal values, applied transformations, and parameter adjustments, the tamper-evident safety log employing cryptographic hashing or sequential-integrity constraints.

2. The system of claim 1, wherein the emotion-state feature generator is further configured to compute emotional-intensity values based on polarity magnitude, affect variance, or volatility metrics.

3. The system of claim 1, wherein the emotion-state feature generator computes temporal emotional drift across sequential outputs by comparing feature vectors over a sliding time window.

4. The system of claim 1, wherein the emotion-state feature vectors comprise frequency-domain emotional correlates computed from text-derived signal features.

5. The system of claim 1, wherein the emotion-state feature generator identifies affective-state contradictions through detection of polarity conflicts across emotional dimensions.

6. The system of claim 1, wherein the emotion-state feature generator incorporates historical interaction profiles to adjust feature extraction weightings.

7. The system of claim 1, wherein the emotion-state feature vectors include ambiguity-derived emotional indicators computed from incomplete or uncertain user expressions.

8. The system of claim 1, wherein the linguistic-safety feature evaluator is further configured to detect coercive or dependency-forming language constructs defined in a stored feature table.

9. The system of claim 1, wherein the linguistic-safety feature evaluator computes clarity and specificity scores for the machine-generated output.

10. The system of claim 1, wherein the linguistic-safety feature evaluator detects ambiguity patterns by identifying multi-interpretation phrasing.

11. The system of claim 1, wherein the linguistic-safety feature evaluator computes semantic-deviation values used to detect divergences from expected safe-response patterns.

12. The system of claim 1, wherein tone-adjustment parameters comprise a tone-parameter set stored in a tone-adjustment library.

13. The system of claim 1, wherein length adjustments applied by the transformation module are determined by a length-control rule set stored within the transformation library.

14. The system of claim 1, wherein the composite-risk aggregation engine computes a weighted composite risk signal using an adjustable weight matrix corresponding to emotional and linguistic feature classes.

15. The system of claim 1, wherein the composite-risk aggregation engine increases the weighted composite risk signal when ambiguity or emotional volatility exceeds a predefined threshold.

16. The system of claim 1, wherein the composite-risk aggregation engine applies a multi-stage risk calculation process comprising normalization, weighting, and aggregation phases.

17. The system of claim 1, wherein transformation thresholds are stored in a multi-level threshold table, each level corresponding to a predefined emotional-safety constraint.

18. The system of claim 1, wherein the transformation module selects a stabilization-output template when the weighted composite risk signal exceeds a stabilization threshold.

19. The system of claim 1, wherein domain-specific suppression rules suppress prescriptive, advisory, or directive content when the risk signal surpasses a suppression threshold.

20. The system of claim 1, wherein clarification prompts are generated from query-generation templates stored in a prompt-template library.

21. The system of claim 1, wherein the safety-parameter adaptation module adjusts safety-weight parameters using feedback derived from logged safety events.

22. The system of claim 1, wherein the safety-parameter adaptation module applies reinforcement adjustments when repeated interaction patterns yield increased risk signals.

23. The system of claim 1, wherein the safety-parameter adaptation module detects user-specific emotional-sensitivity patterns and modifies parameters accordingly.

24. The system of claim 1, wherein the safety-parameter adaptation module applies rate-limited parameter adjustments to prevent destabilizing model behavior.

25. The system of claim 1, wherein the tamper-evident safety log stores entries using append-only sequential integrity constraints.

26. The system of claim 1, wherein the tamper-evident safety log employs cryptographic hashing for integrity validation.

27. The system of claim 1, wherein the system generates influence records that indicate how the weighted composite risk signal modified or suppressed the output.

28. The system of claim 27, wherein the influence records comprise parameter-adjustment traces, transformation identifiers, and risk-signal levels.

29. The system of claim 1, wherein the tamper-evident safety log stores regulatory-flag indicators associated with safety events.

30. The system of claim 1, wherein the input acquisition module is configured to receive multimodal inputs comprising text, audio, video, or sensor signals.

31. The system of claim 30, wherein multimodal affective-signal features are extracted from audio, video, or sensor inputs.

32. The system of claim 1, wherein the system is deployed as a cloud-based service accessible via an application programming interface.

33. The system of claim 1, wherein the system is embedded within a local client device comprising a mobile device, wearable device, or personal computing device.

34. The system of claim 1, wherein the system governs outputs generated by distributed or edge-deployed machine-learning models.

35. The system of claim 1, further comprising a model-selection mechanism configured to determine which of multiple models generates an initial output.

36. The system of claim 35, wherein the system includes a semantic-deviation evaluator configured to detect output divergences between models.

37. The system of claim 35, wherein a safety-arbitration module selects or synthesizes a final response based on safety-weighted parameters.

38. The system of claim 35, wherein a governance module enforces output-gating rules preventing models from generating content exceeding predefined emotional-risk thresholds.

39. The system of claim 35, wherein safety consistency across models is computed using cross-model deviation thresholds.

40. The system of claim 1, wherein a crisis-risk estimator generates real-time risk scores based on incoming content.

41. The system of claim 40, wherein the multi-level threshold table defines at least three discrete emotional-risk thresholds.

42. The system of claim 40, wherein the transformation module outputs a crisis-stabilization template when a top-level threshold is reached.

43. The system of claim 40, wherein the system redirects interactions to human support channels upon reaching a maximum risk threshold.

44. The system of claim 40, wherein a temporal-risk memory module retains short-term emotional patterns that influence subsequent risk calculations.

45. The system of claim 40, wherein prescriptive or domain-specific directives are suppressed when the crisis threshold exceeds a suppression limit.

46. The system of claim 1, wherein the transformation module selects predefined behavioral profiles stored in a behavioral-profile table.

47. The system of claim 1, wherein the system applies risk-adaptive gating logic governing allowable output categories.

48. The system of claim 1, wherein the system employs stacked safety constraints combining tone control, length control, suppression rules, and threshold constraints.

49. The system of claim 1, wherein the tamper-evident safety log stores regulatory-compliance parameters representing jurisdiction-specific emotional-safety requirements, and wherein the transformation module applies output constraints based on those regulatory-compliance parameters.

50. The system of claim 1, wherein exceeding at least one predefined transformation threshold causes a compute-state transition that alters execution behavior of a machine-learning generation pipeline, the alteration comprising at least one of suspending token generation, switching to a constrained execution mode, invoking a secondary safety-specific model, or terminating an active generation process.

51. The system of claim 50, wherein the compute-state transition further comprises modifying computational resource allocation, including throttling processing cycles, limiting memory usage, altering inference batch size, or routing execution to specialized safety hardware.

52. The system of claim 1, wherein the composite-risk aggregation engine applies a non-linear integration function that produces a composite risk signal exhibiting a magnitude greater than a linear sum of individual emotional-state feature vectors and linguistic-safety feature sets when conflicting or compounding risk indicators are detected.

53. The system of claim 1, wherein exceeding one or more transformation thresholds triggers a governance-state transition that dynamically reconfigures permissible output categories, allowable response structures, or model-selection rules until a subsequent reduction in the composite risk signal is detected.

54. The system of claim 1, wherein application of the transformation module reduces measurable system instability over time by decreasing at least one of emotional volatility variance, escalation frequency, repetitive dependency-forming constructs, or cross-session affective drift relative to an ungoverned generation system.
